(19) United States
(12) Patent Application Publication
(10) Pub. No.: US 2008/0282248 A1
(43) Pub. Date: Nov. 13, 2008

(54) Electronic computing device capable of specifying execution time of task, and program therefor

(75) Inventors: Daisuke Tokumochi, Kariya-city (JP); Takahiko Mori, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/149,685

(22) Filed: May 6, 2008

(30) Foreign Application Priority Data
May 7, 2007 (JP) 2007-122195

(51) Int. Cl. G06F 9/46

(52) U.S. Cl. 718/102

(57) ABSTRACT

When an execution time of a task is short the execution time of the task can be reliably specified and erroneous calculation of an execution time due to other processing can be prevented. A task designated in advance and a task whose execution is initiated are collated with each other. When the tasks are compared with each other, the initiation time of the executing task is recorded at the initiation of the executing task and the difference between the termination time and the initiation time is recorded as an execution time when the executing task terminates.

### CROSS REFERENCE TO RELATED APPLICATIONS

The present application is based on and claims priority to Japanese Patent Application No. JP 2007-122195 filed May 7, 2007 the contents of which are incorporated in their entirety herein.

### BACKGROUND OF THE INVENTION

1. Field of the Invention

The present invention relates to an electronic computing device and more specifically to one capable of switching from one to another among multiple tasks to be executed by a CPU, of specifying an execution time of a task, and a program for carrying out such a capability.

2. Description of the Related Art

In the past, various technologies have been proposed for specifying an amount of a task execution time spent by a CPU that switches from one to another among multiple tasks to be executed. As a method for specifying the execution time of a task, for example, there is a procedure that is repeated every time a task is executed involving setting a predetermined flag in a RAM to 1 at the execution initiation time of a task, and resetting the flag to 0 at the execution ending time of the task. A change in the flag is cyclically checked using an external device such as a RAM monitor. Using the above described method, a task execution ratio of the CPU, that is, a utilization ratio of the CPU can be specified from a ratio of a period, during which the RAM flag is set to 1, to a certain period.

As a method for specifying an execution time of a task, there is a method described in Japanese Patent Application No. JP-A-5-40651 and Japanese Patent No. 3,376,096 where an idle task is executed during a time when an ordinary task is not executed. A counter value is cyclically incremented during the idle task. Consequently, a ratio of a time, during which an ordinary task is not executed, to a certain period can be calculated from the accumulated increments in the counter value made during the certain period. Based on the ratio of counts of execution and non-execution, a ratio of a time during which the ordinary task is executed can be calculated.

However, in the foregoing method, which involves using the external RAM monitor as described, if the time elapsing from the instant of initiating execution of a task to the instant of terminating the execution gets shorter than an interval between checks to be performed by the RAM monitor, the fact that the task has been executed cannot be detected. As a consequence, a result of a calculation performed on an execution time of a task becomes inaccurate.

In the method of incrementing a counter value during an idle task, if any other processing, for example, diagnostic processing of a storage medium is performed during the idle task, the processing affects the timing of executing the processing of incrementing the counter value. As a result, a possibility arises that a rate associate with incrementing the counter value may become unstable. If the rate of incrementing of the counter value is unstable, the result of calculation performed on an execution time of a task becomes inaccurate.

### SUMMARY OF THE INVENTION

The present invention addresses the foregoing problems. An object of the present invention is to provide a mechanism to allow precise specification of an execution time of a task so that even when an execution time of a task is very short, the execution time of the task can be reliably specified and erroneous calculation of an execution time will not be caused by any other processing.

An electronic computing device includes a storage medium and a CPU and switches from one to another among multiple tasks recorded in the storage medium to be executed by the CPU. When the CPU executes one of the multiple tasks which will hereinafter be called an executing task, the CPU decides whether the executing task is a designated task recorded in the storage medium. A designated task is one that is designated for execution time monitoring. Based on the fact that the result of the decision is made in the affirmative, at the execution initiation time of the executing task, the time instant of the initiation time is recorded in the storage medium as the execution initiation time instant of the executing task. Further, at the execution termination time of the executing task, the difference between the execution termination time and the execution initiation time of the executing task recorded in the storage medium is recorded in the storage medium as the execution time of the executing task.

As mentioned above, a task designated in advance and a task whose execution is initiated are collated with each other. If they are squared with each other, the difference between the initiation time instant of the executing task and the termination time instant thereof is recorded as the execution time. Thus, the execution time of a desired task can be specified. Using the above described method, even if an execution time of a task is very short, the execution time can be reliably specified. Erroneous calculation of an execution time will not be caused by any other processing.

The second aspect pertains to an electronic computing device that includes a storage medium and a CPU that switches from one to another among multiple first-group tasks belonging to the first group and multiple second-group tasks belonging to the second group to be executed by the CPU. When the CPU does not execute any of the first-group tasks, the CPU executes one of the second-group tasks without fail.

For each execution of the second-group tasks performed within a predetermined measurement period, the CPU records the instant of initiation as the execution initiation time instant of the executing task in the storage medium for each of the second-group tasks to be executed, hereinafter called executing tasks. At the execution termination time of the executing task, the CPU calculates the difference between the instant of termination and the execution initiation time instant of the executing task, which is recorded in the storage medium, as the execution time of the executing task. The CPU records in the storage medium as the execution time of multiple first-group tasks a result obtained by subtracting the sum total of the execution times of the executing tasks, which are calculated within the measurement period, from the measurement period.

As mentioned above, tasks to be executed by the CPU are divided into the first group and second group. While a task belonging to the first group is not executed, a task belonging to the second group is executed without fail. In such a case, the execution times of tasks belonging to the second group are measured within a certain measurement period. A value obtained by subtracting the sum total of the results of the measurements from the measurement period can be specified as the execution time of the first-group tasks.

As for each of the second-group tasks, the difference between the initiation time instant of each executing task and the termination time instant is specified as the execution time thereof. Thus, the execution time of the task can be specified. Using the above described method, even if the execution time of a task is very short, the execution time can be reliably specified. Erroneous calculation of an execution time will not be caused by any other processing.

In accordance with a second aspect, tasks belonging to the second group may be platform tasks that directly control hardware of the electronic computing device and an operating system thereof. Tasks belonging to the first group may be application tasks that utilize the hardware of the electronic computing device and the operating system thereof via the platform tasks. Thus, a general need to learn a CPU utilization ratio of an application task can be coped with.

A facility for recording in the storage medium as an execution time of an application task a result obtained by subtracting the sum total of the execution times of executing tasks, which are calculated within a measurement period, from the measurement period may be implemented as a platform task. Thus, a calculation facility for calculating an execution time of an application task can be designed as an integral part of a platform. A designer of an application task need not create a program that calculates the execution time of the application task.

It will be appreciated that the first and second features of the present invention may be realized as programs. That is the invention can be embodied as a computer readable medium such as a storage device or communication channel, with instructions that, when read, cause a processor or computer to execute certain functions.

### BRIEF DESCRIPTION OF THE DRAWINGS

Other objects, features and characteristics of the present invention will be appreciated and become apparent to those of ordinary skill in the art and all of which form a part of the present application. In the drawings:

FIG. 1 is a block diagram illustrating an exemplary configuration of an electronic control unit (ECU) of an embodiment and the connectional relationship thereof to a RAM monitor;

FIG. 2 is a diagram illustrating an exemplary hierarchy of software to be executed by a central processing unit (CPU);

FIG. 3 is a timing diagram illustrating an exemplary execution sequence of various tasks executed by a CPU;

FIG. 4 is a flowchart illustrating an exemplary task start hook function;

FIG. 5 is a flowchart illustrating of a an exemplary task termination hook function;

FIG. 6 is a flowchart illustrating an exemplary measurement task;

FIG. 7 is a diagram illustrating an exemplary wave representing a change in a total execution time observed when filtering is not performed; and

FIG. 8 is a diagram illustrating an exemplary wave representing a change in a total execution time observed when filtering is performed.

### DESCRIPTION OF THE EXEMPLARY EMBODIMENTS

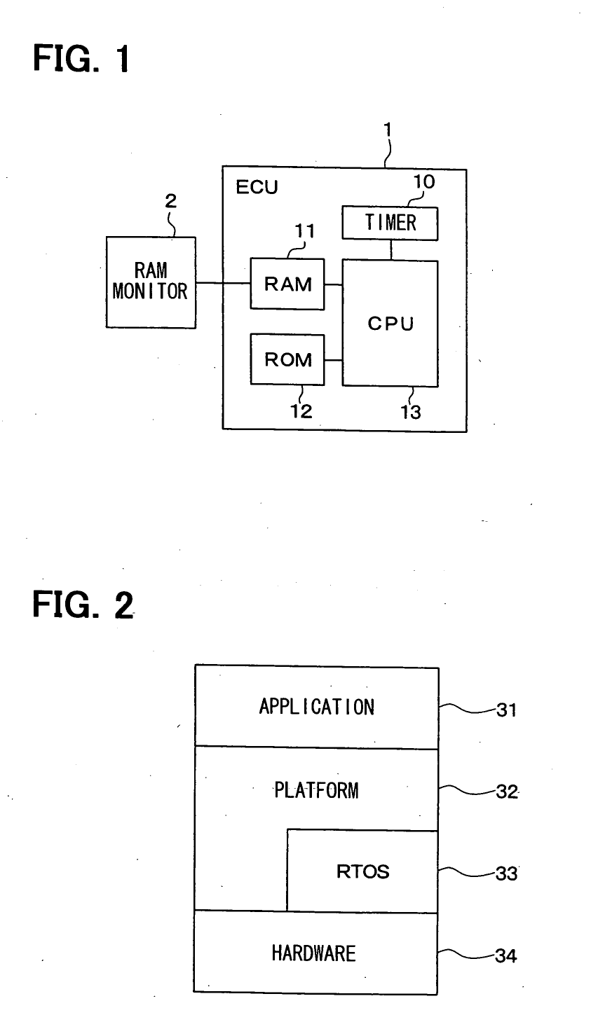

An embodiment to which the present invention is applied will be described below. FIG. 1 shows the configuration of an electronic control unit (ECU) 1 in accordance with the present embodiment and the connectional relationship thereof to a RAM monitor 2. The ECU 1 is an electronic control unit that is mounted in a vehicle in order to control the behavior of the vehicle. For example, the ECU 1 may be an engine ECU.

The ECU 1 includes a timer 10, a RAM 11, a ROM 12, and a central processing unit (CPU) 13. The timer 10 measures the elapse of time. The CPU 13 reads a program from the read only memory (ROM) 12, runs the program, and performs various arithmetic operations using the random access memory (RAM) 11 as a work area during the run time. When performing the arithmetic operations, the CPU 13 may acquire information on the interior of the vehicle from sensors that are not shown, for example, a vehicle speed sensor and an accelerator opening sensor or may control actuators that are not shown, for example, an injector and an anti-lock brake system. The RAM monitor 2 is a device that can read the contents of storage in the RAM 11 when connected to the ECU 1 if necessary.

Now, programs to be run by the CPU 13 will be described below. Programs stored in the ROM 12 include real-time operating system (RTOS) programs, platform programs, and application programs. FIG. 2 shows the conceptual hierarchy of an application 31, a platform 32, and an RTOS 33 in relation to hardware 34. The RTOS 33 is a system that directly controls the hardware 34 of the ECU 1 including the RAM, the ROM, and an I/O device that is not shown. As the RTOS 33, for example, any RTOS conformable to the OSEK specifications may be adopted (OSEK is a registered trademark of Siemens AG). The platform 32 is a system that directly controls the hardware 34 and RTOS 33.

The application 31 is a system in which various capabilities of the ECU 1, for example, capabilities of engine control, automatic cruise control, and lane keep control are implemented. For thus purpose, the application 31 utilizes the hardware 34 and RTOS 33 via the platform 32. Due to the presence of the hierarchy, the application need not directly utilize the facilities of the RTOS 33 and hardware 34. Consequently, once an interface between the platform 32 and application 31 is allowed to be used in common, since the platform 32 absorbs the difference between the RTOS 33 and hardware 34 in each ECU, the same application 31 can be used in common among different types of ECUs. In other words, reallocation of the application 31 is permitted.

The programs in the ROM are classified into program units called tasks. The CPU 13 executes one of the multiple tasks at one time. The CPU 13 sequentially switches a task to be executed from one to another according to a priority sequence predefined among tasks. The facility of switching executing tasks shall be called a task scheduling facility. The task scheduling facility is implemented in the RTOS 33.

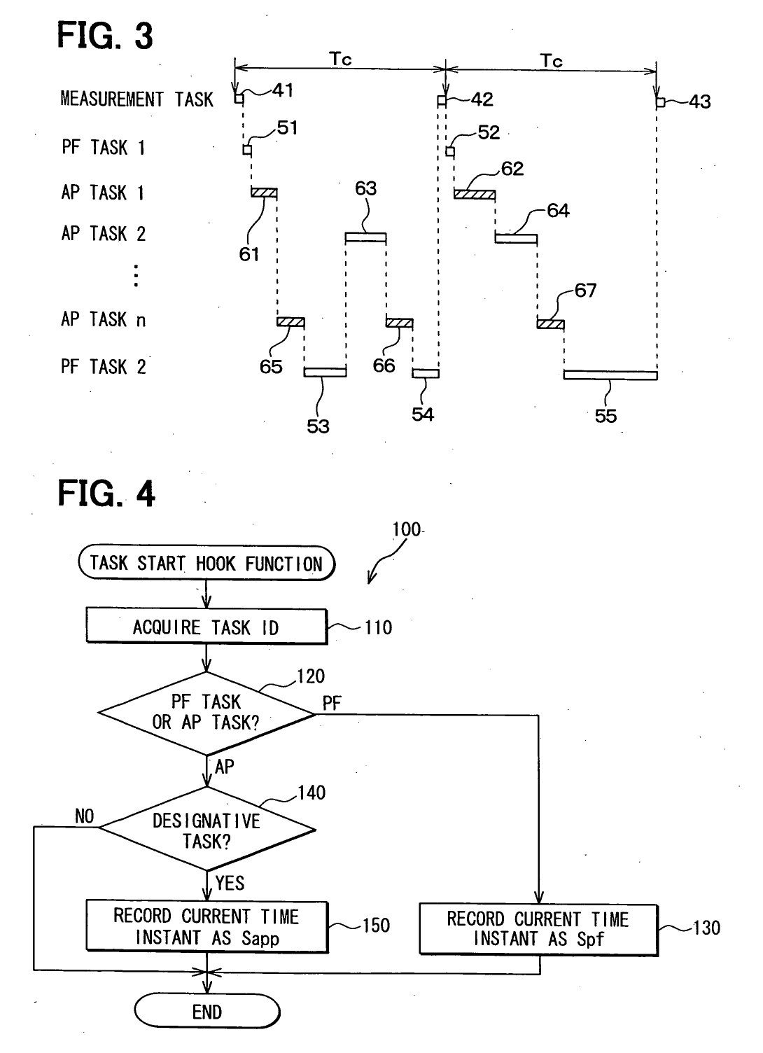

FIG. 3 shows an example of an execution sequence of various tasks in which the CPU 13 executes the tasks. In the present example, the CPU 13 executes a measurement task, a PF task 1, AP tasks 1, 2, . . . , and n, and a PF task 2. It should be noted that AP tasks can refer to tasks such as first-group tasks that are regarded as application programs, and PF tasks can refer to tasks such as second-group tasks that are regarded platform programs. Priorities are assigned to the tasks in descending order. For example, assuming that the execution timing 63 of the AP task 2 comes at the execution timing 53 of the PF task 2 that is an idle task to be executed when any other program need not be executed, the CPU 13 terminates the execution of the PF task 2 and initiates the execution of the AP task 2. The measurement task to which a priority higher than the priorities given to the other AP tasks and PF tasks is given is executed at intervals of a given cycle Tc, for example, 1 ms in response to a timer interrupt.

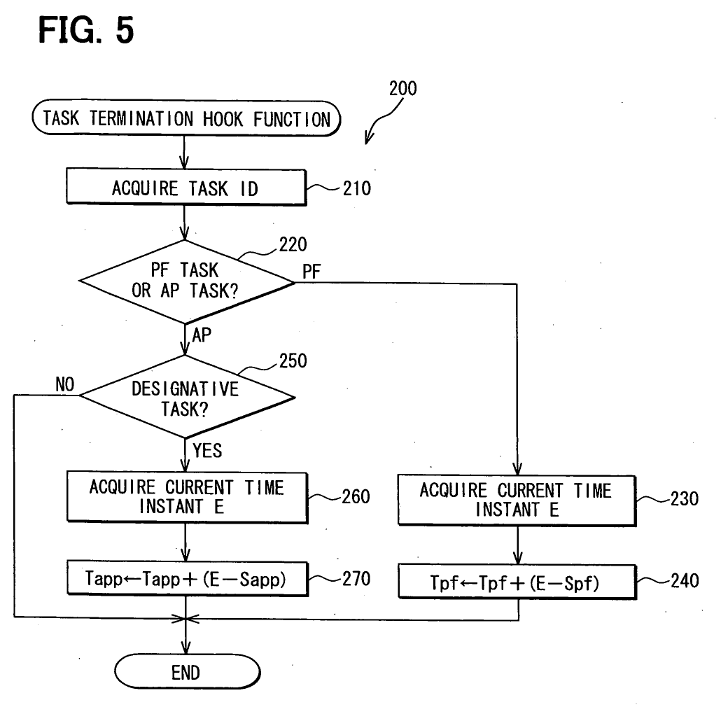

Based on facilities provided by the RTOS, the CPU 13 executes a task start hook function at the execution initiation time of each task, and executes a task termination hook function at the termination time of each task. FIG. 4 and FIG. 5 are flowcharts presenting the contents of processing implemented by the task start hook function 100 and task termination hook function 200 respectively.

For execution of the task start hook function 100, the CPU 13 acquires a task ID of a task to be started at S110. What is referred to as the task ID is a code assigned to each task in advance, or more particularly, during design in order to discriminate one task from another task. Depending on the contents of the task ID, whether the task is an AP task or a PF task can be decided. Since a task ID acquisition method is already known, the details will not be described.

Thereafter, at S120, whether the acquired task ID indicates a PF task or an AP task is decided. If a decision is made that the task ID indicates a PF task, a current time instant is acquired based on an output signal sent from the timer 10 at S130. The current time instant is recorded as a variable Spf in the RAM 11. Thereafter, the execution of the task start hook function 100 is ceased.

If a decision is made at S120 that the task ID indicates an AP task, it is then decided whether a task whose execution has been initiated, which will hereinafter be called an executing task, is designated as a task to be subjected to execution-time measurement, which will hereinafter be called a designated task. The decision is made depending on whether the task ID acquired at S110 is squared with one designated task ID or any of multiple designated task IDs recorded in advance in the RAM 11, ROM 12, or a nonvolatile writable storage medium that is not shown. As for the designated task ID, a worker may be able to record the designated task ID in the RAM 11 at any time using an external device such as the RAM monitor 2.

If an executing task is not one of designated tasks, the execution of the task start hook function 100 is ceased. If an executing task is one of designated tasks, a current time instant is acquired based on an output signal sent from the timer 10 at S150. The current time instant is recorded as a variable Sapp in the RAM 11. Thereafter, the execution of the task start hook function 100 is ceased.

As mentioned above, at the execution initiation time of a task, if the task is a PF task or a designated task, the CPU 13 records in the RAM 11 the time instant of the initiation time as the execution initiation time instant of the AP task or the execution initiation time instant of the PF task.

For execution of the task termination hook function 200, the CPU 13 first acquires a task ID of a task to be terminated at S210. Thereafter, at S220, whether the acquired task ID indicates a PF task or an AP task is decided. If a decision is made that the task ID indicates a PF task, S230 is executed subsequently. If a decision is made that the task ID indicates an AP task, S250 is executed subsequently.

At S230, a current time instant E is acquired from the timer 10. Thereafter, at S240, a result obtained by subtracting the value of a variable Spf from the current time instant E is added to the value of a variable Tpf. The result obtained by subtracting the value of the variable Spf from the current time instant E represents the time having elapsed from the initiation time of a task whose execution is about to be ceased to a current time, that is, an execution termination time. In other words, the subtracted value represents the execution time of the executing task. The variable Tpf is, as described later, reset to zero at the time of executing the measurement task. Consequently, the variable Tpf represents a total execution time of PF tasks executed from the time when the measurement task is executed last to the current time. After S240, the execution of the task termination hook function 200 is ceased.

At S250, whether a task being terminated is a designated task is decided. If the task is not a designated task, the execution of the task termination hook function 200 is ceased. If the task is a designated task, S260 is executed. At S260, the current time instant E is acquired from the timer 10. Thereafter, at S270, a result obtained by subtracting the value of the variable Sapp from the current time instant E is added to the value of the variable Tapp. The result obtained by subtracting the value of the variable Sapp from the current time instant E represents the time having elapsed from the initiation time of a task whose execution is about to be ceased to the current time, that is, an execution termination time. In other words, the subtracted value represents the execution time of the executing task. The variable Tapp, to be described in greater detail hereinafter, is reset to zero at the time of executing the measurement task. Consequently, the variable Tapp represents the total execution time of all designated tasks executed from the time when the measurement task is executed last to the current time. After S270, the execution of the task termination hook function 200 is ceased.

As mentioned above, at the execution termination time of a task, if the task is a PF task or a designated task, the CPU 13 specifies the difference between the time instant of the termination time and the execution initiation time instant of the task recorded in the RAM 11 as the execution time of the task of this time, and adds the specified execution time to the variable Tpf or variable Tapp. As a result, immediately before the next execution timing of the measurement task, the total execution time of all PF tasks executed during a period Tc is specified in the variable Tpf, and the total execution time of all designated AP tasks executed during the period Tc is specified in the variable Tapp. For example, in FIG. 3, assuming that the AP task 1 and AP task n are designated tasks, the sum total of the execution times 61, 65, and 66 refers to the total execution time Tapp of designated tasks executed during the period Tc from the execution timing 41 of the measurement task to the execution timing 42 thereof. The sum total of the execution times 62 and 67 refers to the total execution time Tapp of designated tasks executed during the period Tc from the execution timing 42 of the measurement task to the execution timing 43 thereof.

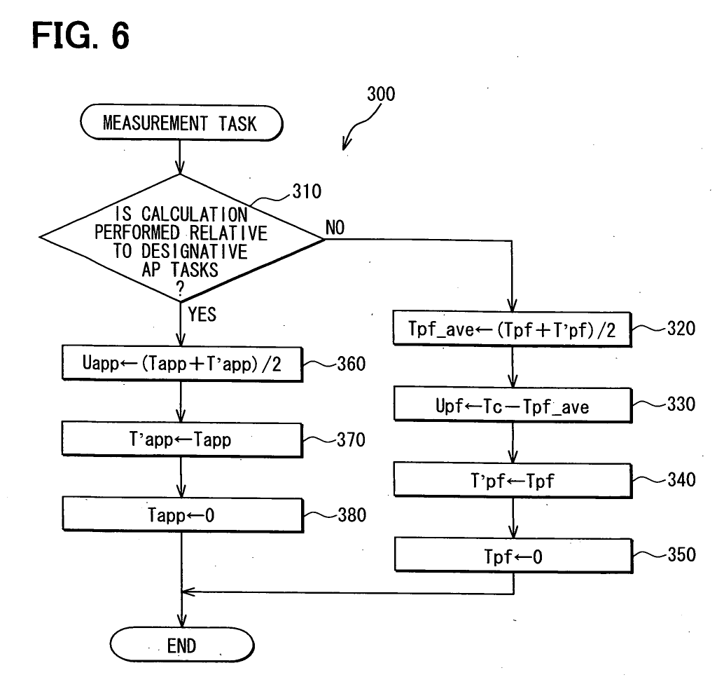

Now, the measurement task 300 will be described in detail in connection with FIG. 6, which is a flowchart describing exemplary aspects thereof. For execution of the measurement task 300, the CPU 13 first decides at S310 whether the CPU 13 should calculate a CPU utilization time spent by designated AP tasks or calculates a CPU utilization time spent by all AP tasks.

The decision is made based on a set value recorded in advance in the RAM 11, ROM 12, or a writable nonvolatile storage medium that is not shown. The set value may be determined in the course of manufacturing the ECU 1, or the set value in the RAM 11 may be recorded at any time, such as during manufacture, using an external device such as the RAM monitor 2.

For calculation of the CPU utilization time spent by all AP tasks, a mean value of the variable Tpf and a variable Tpf′ is assigned to a variable Tpf_ave. The variable Tpf′ represents, as described later, the total execution time of PF tasks executed from the execution timing preceding the immediately preceding execution timing of the measurement task 300 to the immediately preceding execution timing thereof. Since the variable Tpf represents the total execution time of PF tasks executed from the current execution timing of the measurement task 300 to the immediately preceding execution timing thereof, the variable Tfp_ave represents a mean value of the total execution times of PF tasks executed over two immediately previous successive periods Tc. The processing is a kind of filtering processing to be performed on the total execution time that varies depending on the period Tc.

At S330, a result obtained by subtracting the variable Tpf_ave from the period Tc is assigned to a variable Upf. The value of the variable Upf represents the time within the period Tc during which no PF task is executed. In the present embodiment, when any other task is not executed, the PF2 task is executed without fail. What is referred to as the time during which no PF task is executed is identical to the time during which a task other than the PF tasks is executed. Consequently, the variable Upf represents the total execution time within the period Tc during which all AP tasks are substantially executed.

Thereafter, as processing to be performed for the next period Tc, the current value of the variable Tpf is assigned to the variable Tpf′ at S340. At S350, the variable Tpf is reset to zero. Consequently, at the next execution of the measurement task 300, the variable Tpf′ is used as the total execution time of PF tasks executed during the period Tc immediately preceding the execution time of the measurement task 300. After S350, the execution of the measurement task 300 is ceased. Through the processing ranging from S320 to S350, a mean value of the execution times of all AP tasks executed over two immediately previous periods Tc can be calculated. By dividing the execution time by the period Tc, a CPU utilization ratio for all AP tasks executed over the two immediately previous periods Tc can be specified.

For calculation of a CPU utilization time spent by designated AP tasks alone, at S360, a mean value of the variable Tapp and a variable Tapp′ is assigned to the variable Tapp_ave. Herein, the variable Tapp′ represents, as described later, a total execution time of designated AP tasks executed from the execution timing preceding the immediately preceding execution timing of the measurement task 300 to the immediately preceding execution timing thereof. Since the variable Tapp represents a total execution time of designated AP tasks executed from the current execution timing of the measurement task 300 to the immediately preceding execution timing thereof, the variable Tapp_eve represents a total execution time of the designated AP tasks executed over two immediately previous successive periods Tc. The processing is a kind of filtering processing to be performed on the total execution time that varies depending on the period Tc.

Thereafter, as processing to be performed for the next period Tc, the current value of the variable Tapp is assigned to the variable Tapp′ at S370, and the variable Tapp is reset to zero at S380. Consequently, at the next execution of the measurement task 300, the variable Tapp′ is used as the total execution time of PF tasks executed during the period Tc immediately preceding the execution time of the measurement task 300. After S380, the execution of the measurement task 300 is ceased. Through the processing ranging from S360 to S380, a mean value of execution times of all AP tasks executed over two immediately previous periods Tc can be calculated. By dividing the execution time by the period Tc, a CPU utilization ratio for all designated AP tasks executed over the two immediately previous periods Tc can be specified.

As mentioned above, for each task, since the difference between the initiation time instant of the task and the termination time instant thereof is specified as an execution time, the execution time of the task can be specified. Using this method, even when the execution time of a task is very short, the execution time can be reliably specified. Erroneous calculation of an execution time will not be caused by any other processing executed as part of an idle task.

As mentioned above, a task ID of an AP task designated in advance and a task ID of an AP task whose execution is initiated are collated with each other. If they are squared with each other, the difference between the initiation time instant of the AP task and the termination time instant thereof is recorded as the execution time. Thus, the execution time of a desired task can be specified.

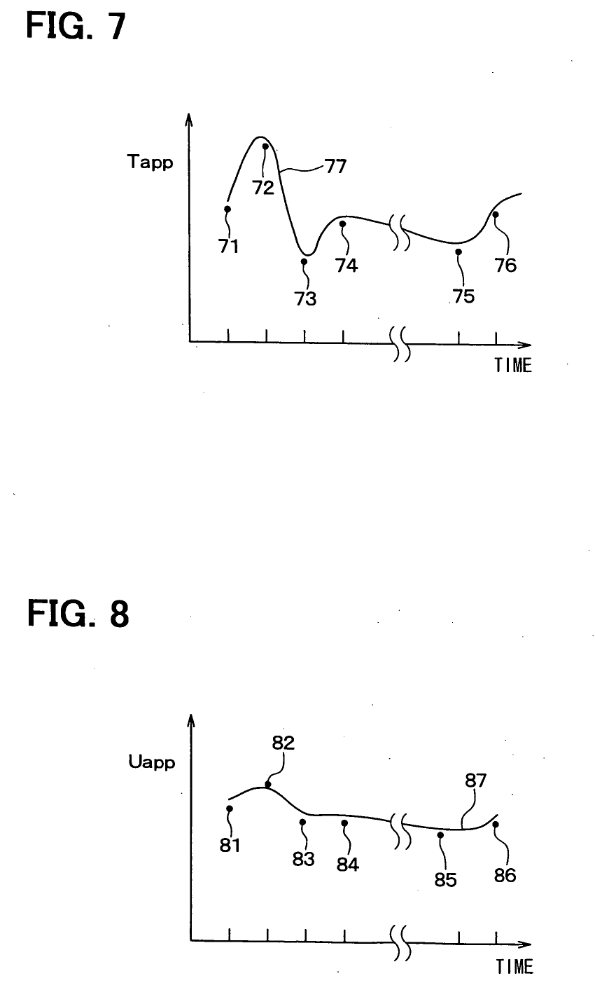

Filtering processing is performed on a total execution time of execution times of all AP tasks or all designated AP tasks, which are calculated relative to each period Tc, by employing the results of calculations relevant to multiple previous periods Tc. If the filtering processing is not performed, a variance among values 71 to 76 relevant to different periods Tc is, as shown in FIG. 7, so large that the shape of a wave 77 plotted based on the calculated values 71 to 76 fluctuates violently.

However, when filtering is performed, since a variance among values 81 to 86 relevant to different periods Tc is suppressed, the shape of a wave 77 plotted based on the calculated values 81 to 86 fluctuates, as shown in FIG. 8, moderately. Consequently, when a worker acquires data of a result, which has undergone filtering, using the RAM monitor 2, the worker need not perform averaging of results of calculations or the like.

Since a measurement task is implemented as a platform task, a designer of an application task need not produce a program that calculates the execution time of the application task. Consequently, a load of processing a task can be measured irrespective of the contents of a design of an application.

In the aforesaid embodiment, the ECU 1 is equivalent to an example of an electronic computing device, and the RAM 11, ROM 12, and the register in the CPU 13 are equivalent to an example of a storage medium. The CPU 13 serves as an example of a decision means by executing S140 of the task start hook function 100, serves as an example of an initiation time recording means by executing S150, serves as an example of a termination time recording means by executing S270 of the task termination hook function 200, serves as an example of a start/termination time calculation means by executing S240 of the task termination hook function 200, and serves as an example of a result-of-measurement recording means by executing steps 320, 33, 340, and 350 of the measurement task 300.

### Other Embodiment

The invention has been described according to various exemplary embodiments as described above. However, the scope of the invention is not limited to the above described embodiments, but encompasses various forms in which specific features can be implemented.

For example, in the previously described embodiment, the ECU 1 refers to an ECU to be mounted in a vehicle. However, an electronic computing device in accordance with other embodiments may be mounted somewhere other than a vehicle.

In the previously described embodiment, a total execution time of PF tasks may or may not include an execution time of a measurement task since the execution time of the measurement task within a period Tc is much shorter than the period Tc. In either case, measurement of the execution time of an application task will not be largely affected.

The relationship among priorities given to AP tasks and PF tasks is not limited to the relationship shown in FIG. 3. Any relationship will be acceptable.

What is claimed is:

1. An electronic computing device including a storage medium and a CPU, the electronic computing device configured to switch from one to another among a plurality of tasks recorded in the storage medium to be executed by the CPU, wherein the CPU includes:
a decision means that decides whether an executing one of the plurality of tasks is a designated task recorded in the storage medium when execution of the executing task is initiated;
an initiation time recording means that records the time when execution of the executing task is initiated in the storage medium as the execution initiation time of the executing task based on the result of the decision made by the decision means being affirmative; and
a termination time recording means that records a difference between a termination time of the executing task and the execution initiation time of the executing task in the storage medium as the execution time of the executing task, the difference recorded at the execution termination time.

2. An electronic computing device including a storage medium and a CPU, the electronic computing device switching from one to another among a first plurality of tasks belonging to a first group and a second plurality of tasks belonging to a second group, the first and second plurality to be executed by the CPU, wherein:
when the CPU executes none of the first plurality of tasks, the CPU executes any of the second plurality of tasks without fail; and
the CPU includes:
a start/termination time calculation means that:
records an execution initiation time of an executing task of each of executions of the second-group tasks performed within a predetermined measurement period in the storage medium, the execution initiation time recorded as an execution initiation time; and
calculates a difference between the termination time and the execution initiation time instant of the executing task recorded in the storage medium at the execution termination time of the executing task, as the execution time of the executing task; and
a result-of-measurement recording means that records a sum of execution times of executing tasks calculated by the start/termination time calculation means within the measurement period as the execution time of the first plurality of tasks a result obtained by subtracting.

3. The electronic computing device according to claim 2, wherein the tasks belonging to the second group are platform tasks that directly control the hardware of the electronic computing device and the operating system thereof, and the tasks belonging to the first group are application tasks that utilize the hardware of the electronic computing device and the operating system thereof via the platform tasks.

4. The electronic computing device according to claim 3, wherein the result-of-measurement recording means belongs to the platform tasks.

5. An article of manufacture comprising a computer readable medium and a program carried on the computer readable medium, the program including instructions readable by an electronic computing device that includes a storage medium and a CPU, the instructions for causing the CPU to:
switch from one to another among a plurality of tasks to be executed by the CPU, the plurality of tasks recorded in the storage medium;
decide whether an executing task is a designated task designated for execution time monitoring, the designated task recorded in the storage medium, the deciding conducted when execution of the executing task is initiated;
record the execution initiation time of the executing task in the storage medium based on the deciding being affirmative, the recording conducted when execution of the executing task is initiated; and
record a difference between a termination time and the execution initiation time of the executing task in the storage medium as an execution time of the executing task, the recording conducted when execution of the executing task is terminated.

6. An article of manufacture comprising a computer readable medium and a program carried on the computer readable medium, the program including instructions readable by an electronic computing device that includes a storage medium and a CPU, the instructions for causing the CPU to:
switch from one to another among a first plurality of tasks belonging to a first group and a second plurality of tasks belonging to a second group;
execute any of the second plurality of tasks when the CPU executes none of the first plurality of tasks;
record an execution initiation time of an executing task for each of executions of the second-group tasks performed within a predetermined measurement period in the storage medium, the recording conducted at the execution initiation time of each of second-group tasks to be executed,
calculate a difference between a termination time and the execution initiation time of the executing task recorded in the storage medium, the difference calculated as the execution time of the executing task; and
record a result obtained by subtracting the sum of the execution times of the executing tasks calculated within the predetermined measurement period, the sum subtracted from the predetermined measurement period, the result recorded in the storage medium as the execution time of the first plurality of tasks.
